(19) United States
(12) Patent Application Publication
(10) Pub. No.: US 2010/0299933 A1
(43) Pub. Date: Dec. 2, 2010

(54) Locking-folding utility knife

(75) Inventor: Isaac Vellekamp, Puyallup, WA (US)

Correspondence Address: ROBERT D. VARITZ, P.C., 4915 S.E. 33RD PLACE, PORTLAND, OR, 97202, US

(73) Assignee: Blade-Tech Industries, Inc.

(21) Appl. No.: 12/455,120

(22) Filed: May 27, 2009

(51) Int. Cl. B26B 1/04; B26B 1/08

(52) U.S. Cl. 30/161; 30/162

(57) ABSTRACT

A utility knife includes an elongate handle having a blade track system therein, the blade track system having a blade pivot point therein; an elongate blade mounted in the blade track system, the blade having a blade slot extending along a majority of its length, and a sharpened cutting/scraping edge extending along a side of the blade; wherein the blade is shiftable between a closed configuration, wherein the cutting/scraping edge is enclosed within the handle, to a first open configuration by rotating about the blade pivot point and in the blade track system, wherein the blade extends longitudinally outward from an end of the handle, and wherein the blade is shiftable along the blade track system between the first open configuration and a second open configuration wherein the blade is located towards another end of the handle and extends downwards from a bottom of the handle.

### FIELD OF THE INVENTION

This invention relates to utility knives, and specifically to a utility knife in which the blade both folds into a handle and when opened, locks into an operation position.

### BACKGROUND OF THE INVENTION

Utility knives are known to those of ordinary skill in the art to have many forms, everything from the simple box cutter with a fixed, exposed blade, to machete-style implements. Utility knives with slidable blades are described in U.S. Pat. No. 4,663,845 to Weimann, U.S. Pat. No. 4,761,882 to Silverstein, U.S. Pat. No. 4,941,260 to Castelluzzo, U.S. Pat. No. 6,161,290 to Takamasa, and U.S. Pat. No. 6,513,246 B2 to Ping. A utility knife having both a folding and slidable blade is described in U.S. Pat. No. 4,936,014 to Shaanan et al. U.S. Pat. No. 6,263,581 B1 to Forte describes a hunting utility knife which has a folding, curved blade wherein blade edges are replaceable/interchangeable. U.S. Pat. No. 6,052,908 to Harman describes a utility knife useful for skinning game, which has a curved edge.

For all of the inventiveness which precedes the instant invention, there has not been described a utility knife which provides variable blade positions and which allows the blade to be folded into a carrying position.

### SUMMARY OF THE INVENTION

A utility knife includes an elongate handle having a blade track system therein, the blade track system having a blade pivot point therein; an elongate blade mounted in the blade track system, the blade having a blade slot extending along a majority of its length, and a sharpened cutting/scraping edge extending along a side of the blade; wherein the blade is shiftable between a closed configuration, wherein the cutting/scraping edge is enclosed within the handle, to a first open configuration by rotating about the blade pivot point and in the blade track system, wherein the blade extends longitudinally outward from an end of the handle, and wherein the blade is shiftable along the blade track system between the first open configuration and a second open configuration wherein the blade is located towards another end of the handle and extends downwards from a bottom of the handle.

It is an object of the invention to provide a utility knife which has both a folding and lockable blade, wherein the blade may be locked into plural positions.

Another object of the invention is to provide a utility knife which is convertible into a chopping configuration.

A further object of the invention is to provide a utility knife which is convertible into a scraping configuration.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts the utility knife of the invention in a closed, carrying configuration.

FIG. 2 is a side elevation of the knife of FIG. 1 in a first open, chopping configuration.

FIG. 3 is a top plan view of the knife of FIG. 1 in its first, open, chopping configuration.

FIG. 4 is a side elevation of the knife of FIG. 1 (horizontally flipped) in a first open, chopping configuration, with the right handle slab and side plate removed to show detail.

FIG. 5 is a side elevation of the knife of FIG. 4 in an intermediate configuration, between the first chopping configuration and a second open, scraping configuration.

FIG. 6 is a side elevation of the knife of FIG. 4 in its second open, scraping configuration.

FIG. 7 is a side elevation of a right side plate of the knife of FIG. 1.

### DETAILED DESCRIPTION OF THE PREFERRED EMBODIMENTS

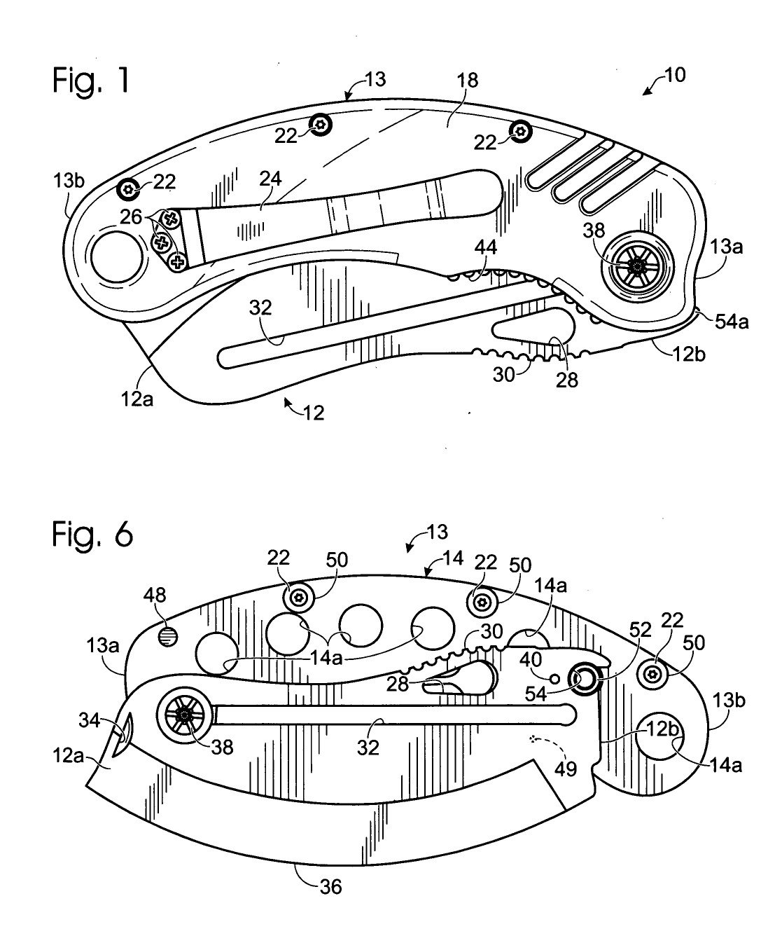

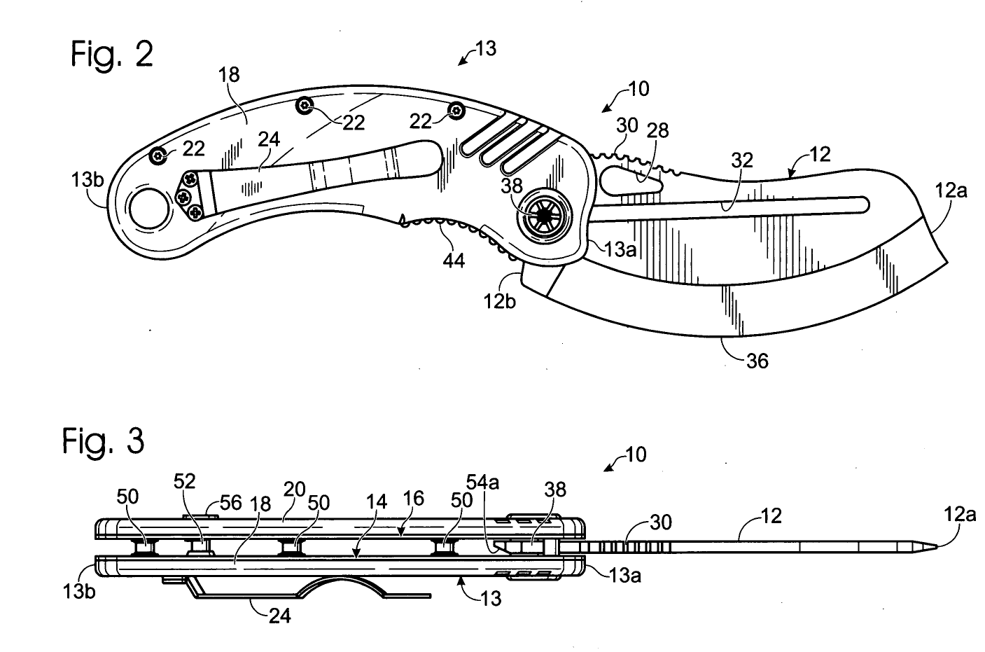

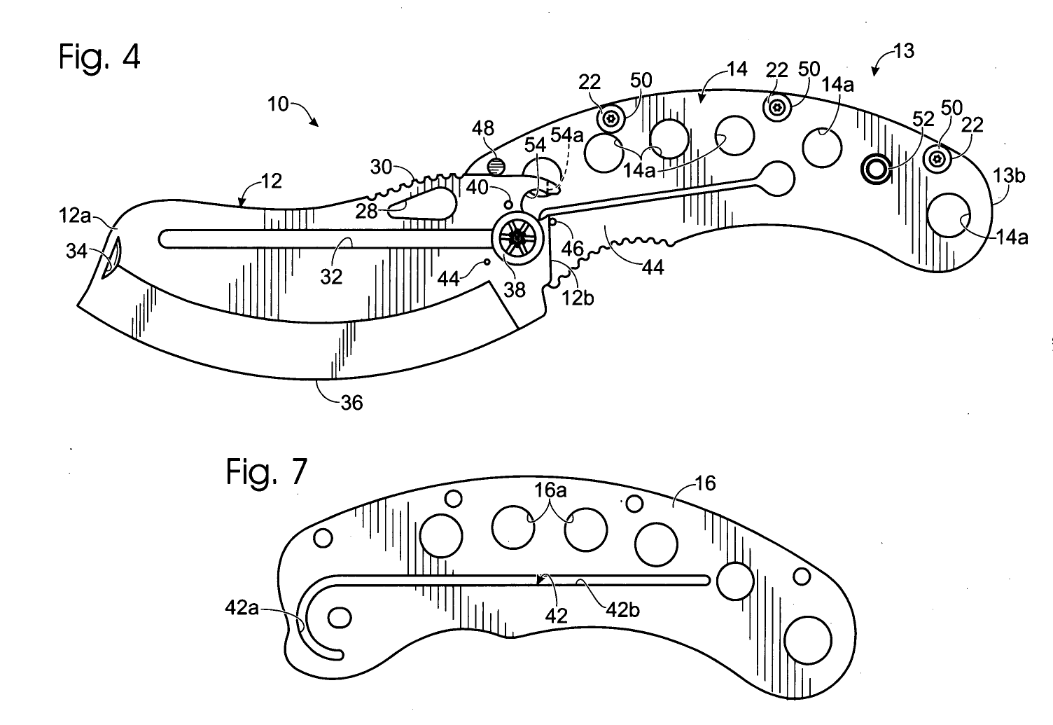

Referring now to FIGS. 1-4, the locking-folding utility knife of the invention is depicted generally at 10. Knife 10 includes an elongate blade 12, which is pivotally and slidably mounted in a handle 13, which includes a right side plate 14 and a left side plate 16, a right handle slab 18 fixed to right side plate 14 and a left handle slab 20 fixed to left side plate 16, by means of fasteners, such as screws 22. In the preferred embodiment, side plates are about 1/16 inch thick and formed of a high-grade steel. As depicted in the drawing figures, side plates 14, 16 have wasted area 14a, 16a, respectively, formed therein to reduce the weight of the finished knife. Also, in the preferred embodiment, the handle slabs are formed of polymer-coated aluminum. Handle 13 has an open construction, as will be explained later herein, to facilitate cleaning. A pocket clip 24 is affixed to right handle slab 18 by means of fasteners, such as screws 26. The knife is shown in a closed configuration in FIG. 1, and depicted in a first open configuration in FIGS. 2-4, which first open configuration is referred to herein as a chopping configuration.

The locking-folding utility knife of the invention allows a user to rotate blade 12 out of handle 13 and into a first open configuration, wherein the blade locks into a position where the blade extends longitudinally outward from the handle. In this configuration, the utility knife may be used for cutting and chopping. Blade 12 may be shifted to a second open configuration where blade 12 extends downwards from the bottom of handle 13, with the blade locked into this second open position, where the utility knife may be used as a scraper, as in scraping hides during a game skinning process. The blade may be shifted back to its first open position and then folded back into handle 13 for safe transporting.

Referring now to FIGS. 2-4, blade 12 includes a thumb hole 28 to facilitate opening of the blade. A notched blade choil 30 is provided to improve control of the blade when in its first opened configuration. A blade slot 32, extending along a majority of the length of blade 12 from adjacent one end 12a of blade 12 to adjacent another end 12b of blade 12 allows for shifting of blade 12 from its first open configuration to a second, open, or scraping, configuration, which operation will be explained in greater detail later herein. A thumb notch 34 is provided to assist in shifting from one configuration to another. Blade 12 includes an arcuate, sharpened cutting/scraping edge 36. A blade pivot pin 38 defines a blade pivot point and secures blade 12 between side plates 14, 16 and is received in blade slot 32, thus, blade 12 rides on blade pivot pin 38 when shifting between configurations. Pivot pin 38 is located adjacent one end 13a of handle 13. A blade travel pin 40 is located above blade slot 32 adjacent the other end 12b of blade 12, and is received in a travel groove 42 formed in left side plate 16, shown in FIG. 7. As seen in FIG. 7, travel groove 42 has a j-shaped configuration, with a hook 42a of the “J” located adjacent one end 13a of handle 13, and a staff 42b of the “J” extending longitudinally towards another, or aft, end 13b of handle 13. Blade slot 32 and blade pivot pin 38, along with travel groove 42 and travel pin 40 comprise what is referred to herein as a blade track system.

Right side plate 14 contains a blade locking mechanism, which includes a blade lock 44, a lock pin 46 and a stop pin 48, collectively referred to herein as a first lock interface, which also includes a detent 49 on blade 12. Blade lock 44, formed by a cut in side plate 14, is slightly bend inwards, and includes an array of notches to insure adequate friction between the blade lock and a user's digit. Blade lock 44 abuts blade other end 12b, preventing movement of blade 12 relative handle 13 when the blade is in its first open configuration. When blade 12 is closed, lock pin 44 is received in detent 49, which maintains blade 12 in its closed position.

Side plates 14, 16 are fastened together by screw fasteners 22 and are spaced apart from one another, i.e., spatially maintained, by spacer posts 50, or spacers, which extend on fasteners 22 between the side plates to provide the aforementioned open construction of handle 13. Blade 12 occupies a part of the space between the side plates.

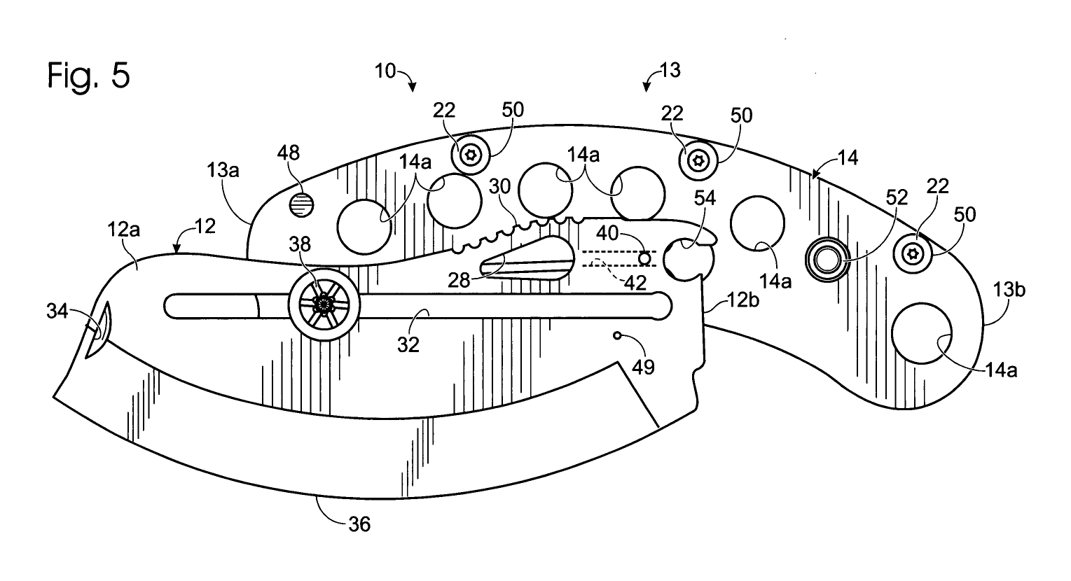

Referring now to FIG. 5, blade 12 is depicted in an intermediate configuration. This configuration is reached from the first open configuration by pressing blade lock 44 to align with the remainder of side plate 14 and shifting blade 12 aft, towards the rear, or other end 13b, of handle 13. Blade 12 travels on blade pivot pin 38 while travel pin 40 moves in travel groove 42. When the blade reaches its full aft travel, a lock receiver 54 receives a spring lock 52, fixing blade 12 in its second, scraping configuration, depicted in FIG. 6. Lock receiver 54 has a ramp 54a which facilitates engagement of spring lock 52, which is displaced towards side plate 16 as blade 12 is shifted aft to its second open configuration, and which then drops into lock receiver 54, fully being seated in the receiver to prevent any movement of blade 12 relative to handle 13 in the second open position. In this configuration, blade pivot pin 38 is located fully forward in blade slot 32. Spring lock 52 and receiver 54 comprise what is referred to herein as a second locking interface, which is located adjacent other end 13b of handle 13. Blade 12 is released from its locked second open configuration by pressing a lock release 56, shown in FIG. 3, allowing blade 12 to be pulled forward, facilitated by thumb notch 34, to its first open position, from which, with sideways movement of blade lock 44, the blade may be rotated to its closed position. When in its closed configuration, knife 10 has a length of about 4⅞ inches. When knife 10 is in its first open configuration, with the blade fully extended, knife 10 has a length of about 8⅝ inches, while, with the knife in its second open configuration, it has a length of about 5¼ inches.

Thus, a multi-function utility knife has been disclosed. It will be appreciated that further variations and modifications thereof may be made within the scope of the invention as defined in the appended claims.

I claim:

1. A utility knife comprising:
an elongate handle having a blade track system therein, said blade track system having a blade pivot point therein;
an elongate blade mounted in said blade track system, said blade having a blade slot extending along a majority of its length, and a sharpened cutting/scraping edge extending along a side of the blade;
wherein said blade is shiftable between a closed configuration, wherein said cutting/scraping edge is enclosed within said handle, to a first open configuration by rotating about said blade pivot point and in said blade track system, wherein said blade extends longitudinally outward from an end of said handle, and wherein said blade is shiftable along said blade track system between said first open configuration and a second open configuration wherein said blade is located towards another end of said handle and extends downwards from a bottom of said handle.

2. The utility knife of claim 1 wherein said handle includes a pair of spaced apart side plates, wherein said blade includes an end which extends longitudinally outward from said handle from one end of said handle in said first open configuration and which has another end thereof received in said handle one end, and which further includes a first locking interface for locking said blade in said first open configuration, which first locking interface includes a blade lock formed in one of said side plates which engages said blade other end to lock said blade relative to said handle in said first open configuration.

3. The utility knife of claim 1 wherein said handle includes a spring lock extending between the side plates thereof adjacent said handle other end and wherein said blade other end includes a lock receiver, wherein, with shifting of said blade aft along said blade track system, said spring lock engages said lock receiver to lock said blade relative to said handle in said second open configuration.

4. The utility knife of claim 1 wherein said handle includes spaced apart side plates which comprise an open configuration, wherein said side plates are partially maintained by spacers secured between said side plates.

5. The utility knife of claim 1 wherein said blade track system further comprises said blade slot and a pivot pin, located at said pivot point, which is received in said blade slot, and a travel groove located in a side plate, having a travel pin, located adjacent said blade other end, slidably received in said travel groove.

6. The utility knife of claim 5 wherein said travel groove has a J-shaped configuration and wherein said travel pin moves through a hook of the J when said blade is shifted between said closed configuration and said first open configuration, and wherein said travel pin moves along a staff of the J when said blade is shifted between said first open configuration and said second open configuration.

7. The utility knife of claim 1 wherein said sharpened cutting/scraping edge has an arcuate perimeter.

8. A utility knife comprising:
an elongate handle having a blade track system therein, said blade track system having a blade pivot point therein;
an elongate blade mounted in said blade track system, said blade having a blade slot extending along a majority of its length, and a sharpened cutting/scraping edge extending along a side of the blade;
wherein said blade is shiftable between a closed configuration, wherein said cutting/scraping edge is enclosed within said handle, to a first open configuration by rotating about said blade pivot point and in said blade track system, wherein said blade extends longitudinally outward from an end of said handle, and wherein said blade is shiftable along said blade track system between said first open configuration and a second open configuration wherein said blade is located towards another end of said handle and extends downwards from a bottom of said handle; and
wherein said blade track system further comprises said blade slot and a pivot pin, located at said pivot point, which is received in said blade slot, and a travel groove located in a side plate, having a travel pin, located adjacent said blade other end, slidably received in said travel groove.

9. The utility knife of claim 8 wherein said handle includes a pair of spaced apart side plates.

10. The utility knife of claim 8 wherein said handle includes spaced apart side plates which comprise an open configuration, wherein said side plates are partially maintained by spacers secured between said side plates.

11. The utility knife of claim 10 wherein said travel groove has a J-shaped configuration and wherein said travel pin moves through a hook of the J when said blade is shifted between said closed configuration and said first open configuration, and wherein said travel pin moves along a staff of the J when said blade is shifted between said first open configuration and said second open configuration.

12. The utility knife of claim 8 wherein said sharpened cutting/scraping edge has an arcuate perimeter.

13. A utility knife comprising:
an elongate handle having a blade track system therein, said blade track system having a blade pivot point therein, wherein said handle includes spaced apart side plates which comprise an open configuration, wherein said side plates are spatially maintained by spacers secured between said side plates;
an elongate blade mounted in said blade track system, said blade having a blade slot extending along a majority of its length, and a sharpened cutting/scraping edge extending along a side of the blade, wherein said blade includes an end which extends longitudinally outward from said handle from one end of said handle in said first open configuration and which has another end thereof received in said handle one end;
wherein said blade is shiftable between a closed configuration, wherein said cutting/scraping edge is enclosed within said handle, to a first open configuration by rotating about said blade pivot point and in said blade track system, wherein said blade extends longitudinally outward from an end of said handle, and wherein said blade is shiftable along said is blade track system between said first open configuration and a second open configuration wherein said blade is located towards another end of said handle and extends downwards from a bottom of said handle, wherein said blade other end includes a lock receiver; and
which further includes a first locking interface for locking said blade in said first open configuration, which first locking interface includes a blade lock formed in one of said side plates which engages said blade other end to lock said blade relative to said handle in said first open configuration, and wherein said handle further includes a spring lock extending between the side plates thereof adjacent said handle other end, wherein, with shifting of said blade aft along said blade track system, said spring lock engages said lock receiver to lock said blade relative to said handle in said second open configuration.

14. The utility knife of claim 13 wherein said blade track system further comprises said blade slot and a pivot pin, located at said pivot point, which is received in said blade slot, and a travel groove located in a side plate, having a travel pin, located adjacent said blade other end, slidably received in said travel groove.

15. The utility knife of claim 14 wherein said travel groove has a J-shaped configuration and wherein said travel pin moves through a hook of the J when said blade is shifted between said closed configuration and said first open configuration, and wherein said travel pin moves along a staff of the J when said blade is shifted between said first open configuration and said second open configuration.

16. The utility knife of claim 13 wherein said sharpened cutting/scraping edge has an arcuate perimeter.
